(19) United States
(12) Patent Application Publication
(10) Pub. No.: US 2009/0133596 A1
(43) Pub. Date: May 28, 2009

(54) PRINTING METHOD AND DEVICE USING CONTROLLED RADIATION OUTLETS FOR CREATING A STRUCTURE

(76) Inventor: Manfred Wiedemer, Ismaning (DE)

Correspondence Address: SCHIFF HARDIN LLP;Patent Dpartment, 6600 Sears Tower, Chicago, IL, 60606-6473, US

(21) Appl. No.: 12/352,162

(22) Filed: Jan. 12, 2009

Related U.S. Application Data
(62) Division of application No. 11/431,851, filed on May 9, 2006.
Application No. 11/431,851 is a division of application No. 10/505,238, filed on Apr. 27, 2005, now abandoned.

(30) Foreign Application Priority Data
Feb. 19, 2002 (DE) 102 06 942.5

(51) Int. Cl. B41F 1/18

(52) U.S. Cl. 101/451

(57) ABSTRACT

In a method and device to generate a print image on a carrier material, a surface of a print carrier is covered with a layer of a fountain solution which is one of ink-repelling and ink-attracting. Ink-attracting and ink-repelling regions are generated via structuring. Ink is applied that adheres to the ink-attracting regions and that is not absorbed by the ink-repelling regions. The applied ink is transferred onto the carrier material. To structure, radiation of a lamp is directed toward the print carrier surface and is controlled via a control element with a control signal.

### RELATED APPLICATIONS

The present application is a divisional of U.S. application Ser. No. 11/431,851, filed May 9, 2006 entitled “Printing Method and Device Using Controlled Radiation Outlets for Creating a Structure”, which was a divisional of U.S. application Ser. No. 10/505,238 filed Apr. 27, 2005 entitled “Printing Method and Device Using Controlled Radiation Outlets for Creating a Structure.”

### BACKGROUND

The method and device concerns generating a print image on a carrier material. On the surface of the print carrier ink-attracting and ink-repelling regions are generated in a structuring process corresponding to the structure of the print image to be generated. On the surface, ink is subsequently applied that adheres to the ink-attracting regions and is not accepted by the ink-repelling regions. The applied ink is transferred onto the carrier material.

In the prior art, offset printing methods operating without water are known whose non-printing regions are fat-repelling and therefore accept no printing ink. In contrast, the printed regions are fat-attracting and accept the fat-containing printing ink. Ink-attracting and ink-repelling regions are distributed on the printing plate corresponding to the structure of the print image to be printed. The printing plate can be used for a plurality of transfer printing events. A new plate with ink-attracting and ink-repelling regions must be generated for each print image.

From U.S. Pat. No. 5,379,698, a method (that is called the Direct Imaging Method) is known in which a printer's copy is created via selective burning-off of the silicon cover layer on a multilayer, silicon-coated film in the printing device. The silicon-free locations are the ink-attracting regions that accept printing ink during the printing event. It requires a new film for each new print image.

In the standard offset method operating with water, hydrophobic and hydrophilic regions are generated on the surface of the print carrier corresponding to the structure of the print image to be printed. Before the application of the ink, a thin moisture film that wets the hydrophilic region of the print carrier is first applied onto the print carrier using application rollers or, respectively, spray devices. The ink roller subsequently transfers ink onto the surface of the print carrier that, however, exclusively wets the regions not covered with the moisture film. The ink is finally transferred onto the carrier material after the inking.

In the known offset printing method, multilayer, process-less thermoprinting plates can be used as print carriers (compare, for example, WO00/16988). On the surface of the print carrier, a hydrophobic layer is removed via partial burn-off and a hydrophilic layer is uncovered, corresponding to the structures of the print image to be printed. The hydrophilic layer can be wetted with an ink-repelling fountain solution. The hydrophobic regions are ink-accepting and can accept printing ink during the print event. A new printing plate must be used to create a new print image.

Furthermore, a method is known from U.S. Pat. No. 6,016,750 in which an ink-attracting substance is separated from a film by means of a thermotransfer method, transferred to the hydrophilic surface of the print carrier and solidified in a fixing process. In the printing process, the hydrophilic regions remaining free are wetted with ink-repelling fountain solution. The ink is subsequently applied on the surface of the print carrier, said ink, however, bonding only on the regions provided with the ink-attracting substance. The inked print image is then transferred onto the carrier material. A new film with the ink-attracting substance is necessary for the creation of a new print image.

In the standard offset method or surface printing method, the wetting of the printing plate with the ink-repelling fountain solution is achieved via a specific roughening and structuring of the plate surface. The surface increase and porosity thereby created generates microcapillaries and leads to an increase of the effective surface energy and thus to a good wetting or spreading of the fountain solution. As further measures, in offset printing wetting-aiding substances are added to the fountain solution. These decrease the surface tension of the fountain solution, which in turn leads to an improved wetting of the surface of the print carrier. The literature Teschner H.: Offsettechnik, 5th edition, Fellbach, Fachschriften-Verlag 1983, pg. 193-202 and pg. 350 is referenced in this context.

From U.S. Pat. No. 5,067,404, a printing method is known in which a fountain solution is applied to the surface of the print format. The fountain solution is vaporized via selective application of radiant energy in image regions. The water-free regions later form the ink-bearing regions that are directed to a developing unit and are inked by means of an ink vapor. Energy-intensive partial vaporization processes are necessary to generate the structured fountain solution film.

Furthermore, the patent documents WO 97/36746 and WO 98/32608 are referenced. In the method specified in WO 97/36746, the fountain solution is generated via vaporization of a discrete water volume that condenses on the surface of the print carrier. According to WO 98/32608 and the U.S. Pat. No. 6,295,928 derived therefrom, a continuous ice film is applied and structured. In both cases, local high thermal energy must be applied for structuring. The aforementioned documents U.S. Pat. No. 5,067,404, WO 98/32608 (U.S. Pat. No. 6,295,928) and WO 97/36746 by the same applicant are herewith included by reference in the disclosure scope of the present patent application.

From DE-A-10132204 (not published) by the same applicant, a CTP method (Computer-To-Press method) is specified whereby multiple structuring processes can be implemented on the same surface of the print carrier. The surface of a print carrier is coated with an ink-repelling or ink-attracting layer. In a structuring process, ink-attracting regions and ink-repelling regions are generated corresponding to the structure of the print image to be printed. The ink-attracting regions are then inked with ink. Before a new structuring process, the surface of the print carrier is cleaned and re-coated with an ink-repelling or ink-attracting layer. A fountain solution layer or an ice layer is used as a layer. This patent document DE-A-10 132 204 is herewith included by reference in the disclosure content of the present patent application.

It is known to expose the surface of light-sensitive print carriers with the aid of laser radiation and therewith to generate latent images. The energy thereby required per image point is, however, insufficient to structure a fountain solution layer.

From WO 01/02170 A by the same applicant, a method and a print device are known to print a carrier material and to clean a print roller. The print carrier possesses a plurality of depressions in which ink can be accepted. In a structuring process, this ink in the depressions is charged with a thermal energy, whereby ink-printing regions and regions that emit no ink are generated. The surface of the print carrier is completely cleaned with the aid of a complex cleaning station before a restructuring. This document is likewise included by reference in the disclosure contents of the present application.

From the essay by Larry J. Hornbeck, “From Cathode Rays to Digital Micro Mirrors: A history of electronic projection display technology”, July through September 1998, various control elements are known with whose help radiation can be modulated. For example, in this essay micro-mirror elements (also called DMD) are specified that change the reflection deflection angle given application of voltage.

From U.S. Pat. No. 4,764,776, PLZT elements are known with whose help an optical character generator for printers can be fashioned. Furthermore, the design and the use of SELFOC elements in known in this document.

In the documents EP 0 746 470 B1, EP 0 756 544 B1, digital printing methods are specified in which thermal energy is used for structuring of the surface of a print carrier. Different print images can be generated and then transfer-printed on the same surface.

### SUMMARY

It is an object to specify a printing method and a print device that is designed simply for digital printing with variable print image and allows a precise structuring on the surface of the print carrier.

In a method and system to generate a print image on a carrier material, a surface of a print carrier is covered with a layer of a fountain solution which is one of ink-repelling and ink-attracting. In a structuring process, ink-attracting and ink-repelling regions are generated corresponding to a structure of the print image to be printed. On the surface ink is applied that adheres to the ink-attracting regions and that is not absorbed by the ink-repelling regions. The applied ink is transferred onto the carrier material. Radiation of a lamp via a control element is directed per image point. With the control element, radiation supplied toward the image surface is controlled.

### BRIEF DESCRIPTION OF THE DRAWINGS

FIG. 1 is a principle representation of a print device in which a surfactant layer is applied;

FIG. 2 shows schematically a cross-section through the print carrier before and after the structuring by a laser beam;

FIG. 3 is an exemplary embodiment in which a hydrophilized layer is structured;

FIG. 4 is an exemplary embodiment in which an applied hydrophilic layer is structured;

FIG. 5 is a schematic cross-section through the print carrier before and after the structuring of the hydrophilic layer;

FIG. 6 is an exemplary embodiment in which the hydrophilization occurs via a corona discharge,

FIG. 7 is a cross-section through an insulated electrode;

FIG. 8 is an arrangement in a plastic print carrier;

FIG. 9 is an example for an indirect corona discharge;

FIG. 10 is a print device with a regulation of the fountain solution layer thickness;

FIG. 11 shows the principle design of a PLZT element used for the structuring which acts as a radiation valve;

FIG. 12 is a side view of a structuring arrangement with a PLZT array;

FIG. 13 shows the structuring arrangement according to FIG. 12 in plan view;

FIG. 14 shows a principle representation for a micro-mirror element (DMD element);

FIG. 15 shows a structuring device with a DMD array;

FIG. 16 shows a print device with a cup structure on the surface of the print carrier; and

FIG. 17 is a further print device in which the structuring device structures a fountain solution film or an ice layer.

### DESCRIPTION OF THE PREFERRED EMBODIMENTS

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

According to the preferred embodiment, the radiation of a customary radiation source is used for structuring. Its radiation is directed per image point via a control element operating as a radiation valve. Via the use of an efficient lamp, sufficient energy can be sent onto the surface in order to structure fountain solution layers or hydrophilic layers there.

According to a further aspect of the preferred embodiment, a print device is specified via which the method can be realized.

It is to be noted that the term ink-repelling or ink-accepting layer occurs frequently in the further specification. This layer is adapted to the ink to be applied. For example, given a water-containing fountain solution layer and an oil-containing ink, the fountain solution layer is ink-repelling. However, if the ink is water-containing, this fountain solution layer is ink-attracting. In practice, oil-containing inks are predominantly used, such that a water-containing fountain solution layer is ink-repelling.

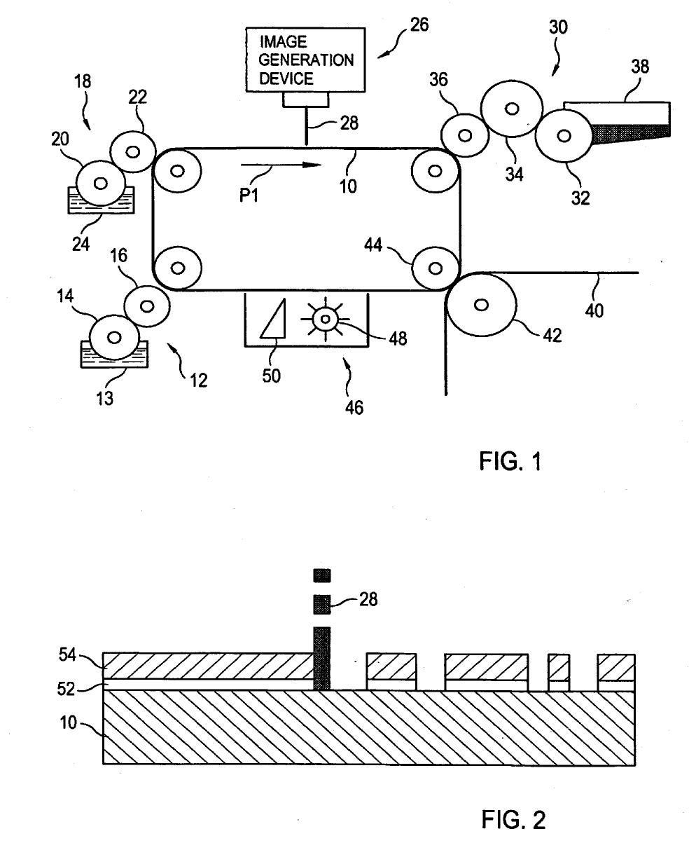

In FIG. 1, a principle representation of a print device is shown that is designed similar to how it is specified in U.S. Pat. No. 5,067,404 by the same applicant. A print carrier 10, in the present case a continuous band, is directed through a pre-treatment device 12 that comprises a scoop roller 14 and an application roller 16. The scoop roller 14 dips into a fluid contained in a reservoir 13, the fluid containing a wetting-aiding substance. This substance, which comprises surfactants, is applied in a molecular layer thickness on the surface of the print carrier 10 via the application roller 16. The layer thickness is typically smaller than 0.1 μm. The surface of the print carrier 10 is then directed in arrow direction P1 to a dampening system 18 that, via a scoop roller 20 and an application roller 22, applies an ink-repelling or ink-attracting fountain solution, for example water, from a fountain solution reservoir 24 onto the surface of the print carrier 10. In principle, other fountain solution than water can also be used. The application of the fountain solution layer can also occur via other methods, for example via vaporization or spraying. The print-active surface of the print carrier 10 is completely provided with this fountain solution layer. The fountain solution layer typically has a layer thickness smaller than 1 μm.

The generally ink-repelling fountain solution layer is subsequently structured via an image generation device 26. In the present case, laser radiation 28 is used for this. In this structuring process, ink-attracting regions and ink-repelling regions are generated corresponding to the structure of the print image to be printed. The structured fountain solution layer subsequently arrives at an inking system 30 which transfers ink from a reservoir 38 to the surface of the print carrier 10 with the aid of the rollers 32, 34, 36. The oil-containing ink attaches at regions without water-containing fountain solution. It is to be noted that the ink can also be transferred onto the surface of the print carrier 10 via spraying, scraping or condensation.

Given further transport of the print carrier 10, a transfer printing onto a carrier material 40 (in general a paper web) occurs. For transfer printing, the carrier material 40 is directed through between two rollers 42, 44. In the transfer printing process, a rubber blanket cylinder (not shown) and further intermediate cylinders that effect an ink separation as this is known from the field of offset printing methods can be inserted between the roller 42 and the print carrier 10.

Given further transport of the print carrier 10, the surface of the print carrier 10 is cleaned in a cleaning station 46. The ink residues as well as the residues of the surfactant layer are hereby removed. The cleaning station 46 comprises a brush 48 and a wiping lip 50 which are brought into contact with the surface of the print carrier 10. Furthermore, the cleaning can be supported via use of ultrasound, high pressure liquid and/or vapor. The cleaning can also occur using cleaning fluids and/or solvents.

A new application of the wetting-aiding substance, for example a surfactant application, and a fountain solution application as well as a restructuring can subsequently occur. In this manner, a new print image can be printed given every revolution of the print carrier 10. However, it is also possible to print the same print image multiple times. The cleaning device 46, the device 12 and the device 26 are then inactively interposed. The print image still present in ink residues is then re-inked and transfer-printed by the inking system 30. Given this operating type, a plurality of identical print images can thus be printed.

FIG. 2 schematically shows a cross-section through the print carrier 10 before and after the structuring with the aid of the laser beam 28. According to the preferred embodiment, the wetting via the application of a wetting-aiding substance is conveyed onto the print carrier surface 10. This occurs within the print cycle before the application of the ink-repelling fountain solution. The wetting-aiding substance can be applied on the surface (dependent on its physical and chemical properties) as an extremely thin layer of a few molecule layers, preferably smaller than 0.1 μm. This layer is sufficient in order to promote the wetting with the ink-repelling fountain solution on its free surface, such that this can in turn be applied as a very thin layer 54, preferably smaller than 1 μm. The continuing print process is not impaired by the small quantity of the wetting-aiding substance, in this case a surfactant layer 52. It can easily be removed again via the cleaning process integrated into the print cycle.

Advantages primarily result in the field of surface printing or offset printing, meaning a surface printing method or offset printing method with alternating print information from print cycle to print cycle. Via the wetting-aiding layer 52, the otherwise typical roughened, porous printing plate surface can be foregone. Instead of this, a smooth surface of the print carrier 10 is possible that is to be cleaned with clearly lesser effort. A faster and more stable cleaning event is indispensable for such a digital surface printing method or offset printing method and a decisive factor for its effectiveness. The surface of the print carrier 10 accordingly has a roughness that is smaller than the roughness used in the standard offset printing method. The average surface roughness R_{z} is typically smaller than 10 μm, preferably smaller than 5 μm. Expressed as an average roughness value Rₐ, the roughness value is in a range smaller than 2 μm, preferably smaller than 1 μm.

A change in the molecular or atomic structure of the material of the print carrier as well as a wetting-aiding layer permanently and firmly anchored with the surface of the print carrier is not necessary. The additionally applied wetting-aiding substance (for example the surfactant layer 52) proposed here already deploys its wetting-aiding effect given the smallest quantities. Its influence on the properties of the print carrier 10 in all regards is accordingly negligible. A further advantage results from the now-possible abandonment of the typically present wetting-aiding additives in fountain solutions in offset printing.

According to FIG. 2, the fountain solution layer 54 and the surfactant layer 52 are removed via the laser beam 28 corresponding to the required image structure. These regions are then inked with ink by the inking system 30. The cleaning is eased due to the very smooth surface of the print carrier 10, whereby the surfactant layer 52 is completely removed again. Furthermore, the wear of the surface of the print carrier 10 is reduced.

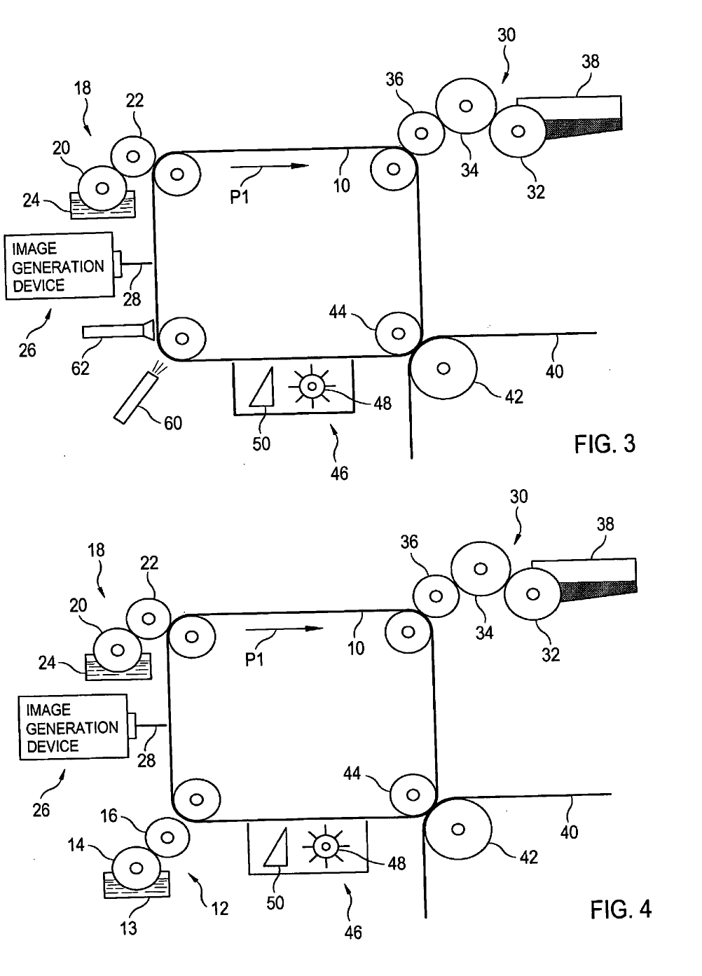

In the following Figures, functionally identical elements are designated identically. FIGS. 3, 4 and 5 show a further exemplary embodiment of the invention. In FIG. 3, in contrast to the exemplary embodiment according to FIG. 1, before the application of the ink-repelling or ink-attracting layer on the usable surface of the print carrier a structuring of a hydrophilic layer occurs with a molecular layer thickness. In the present example, a vapor device 60 is used that charges the surface of the print carrier 10 with hot water vapor. The print carrier 10 is provided with an SiO2 coating on its surface. After the vapor treatment, the print carrier 10 is dried via a suction device 62. The hot water vapor generates a hydrophilic molecule structure, for example SiOH, on the outer surface.

After the subsequent structuring via the structuring device 26 by means of laser radiation 28, hydrophilic and hydrophobic regions are created corresponding to the structure of the print image to be printed. Via the downstream dampening system 18, the entire usable surface of the print carrier 10 is contacted with a fountain solution layer, whereby the fountain solution attaches only to the hydrophilic regions, such that ink-attracting regions and ink-repelling regions are created corresponding to the aforementioned structuring. An ink application via the inking system 30 subsequently occurs, whereby the oil-containing ink attaches to regions without water-containing fountain solution. The transfer printing of the print image onto the carrier material 40 subsequently occurs.

After the further transport of the print carrier 10, its surface is cleaned in a cleaning station 46. The ink residues and the residues of a possible wetting-aiding substance are removed. A new structuring process can subsequently occur.

In the present example according to FIG. 3, the hydrophilic layer on the surface of the print carrier 10 is structured corresponding to the print image. The hydrophilic layer is extremely thin and is only a few nanometers, typically smaller than 4 nm. It can therefore by structured with very low energy expenditure during a print cycle, whereby the hydrophilic molecule layer disappears. The fountain solution application, which generates a fountain solution film only on the non-hydrophilic regions, subsequently occurs. Inking and transfer printing occurs according to the specified known principles of surface printing or offset printing. After the cleaning, in which the hydrophilic layer can also be removed (however does not absolutely have to be removed) in addition to the ink residues, the print cycle can begin anew. The hydrophilic layer is regenerated or reapplied and the hydrophilic layer is subsequently structured corresponding to the new image data.

In the example according to FIG. 3, the generation of the hydrophilic layer ensues via activation of the surface of the print carrier and via a suitable change of the external molecular surface structure. For example, this can be enabled via the use of chemical activators, reactive gases and/or a suitable energy supply. In addition to the use of water vapor as in the example according to FIG. 3, a hydrophilic SiOH structure can be fashioned on the surface via the effect of hot water and via alkaline solutions (such as, for example, NaOH). For this, the print carrier is to be provided with an SiO₂ coating. It is also possible that the print carrier passes through an activator bath in order to generate a hydrophilization of the surface. The application of an activator via a jet system is also possible. A further possibility is to generate the hydrophilic layer via firing the surface of the print carrier 10. Wetting-aiding surface structures are also hereby created in a molecular layer thickness.

An advantageous arrangement is the combination of the hydrophilization with the cleaning. Thus, for example, both the cleaning and the hydrophilizing effect of a hot water jet or, respectively, a hot water vapor jet can be used. The cleaning and the generation of the hydrophilic layer are then implemented in a single process step.

A further variant is shown in FIG. 4. A wetting-aiding substance is hereby applied to the surface of the print carrier to generate the hydrophilic layer. For example, the pre-treatment device 12 specified in the embodiment according to FIG. 1 can be used. With the aid of the scoop roller 14 and the application roller 16, a fluid from the reservoir 13 can be applied that comprises a wetting-aiding substance, for example a surfactant, in a molecular layer thickness. Here as well the layer thickness is typically smaller than 0.1 μm. Alcohols are also considered as a further wetting-aiding substance. The application can alternatively ensue via scraping on, spraying on and vapor deposition.

Due to the very thin hydrophilic layer in molecular layer thickness, the partial removal of this hydrophilic layer can ensue via local thermal energy supply. The energy expenditure can be low due to the low layer thickness. In addition to the laser radiation 28 used in FIGS. 3 and 4, laser diodes, LEDs, LED combs or heating elements can also be used.

In the example according to FIGS. 3 and 4, a restructuring can also ensue per cycle of the print carrier 10, whereby a new print image is printed per cycle. However, it is also possible (as in the example according to FIG. 1) to print the same print image multiple times, whereby the existing print image is re-inked and transfer-printed by the inking system 30. The devices for the restructuring are then inactively interposed.

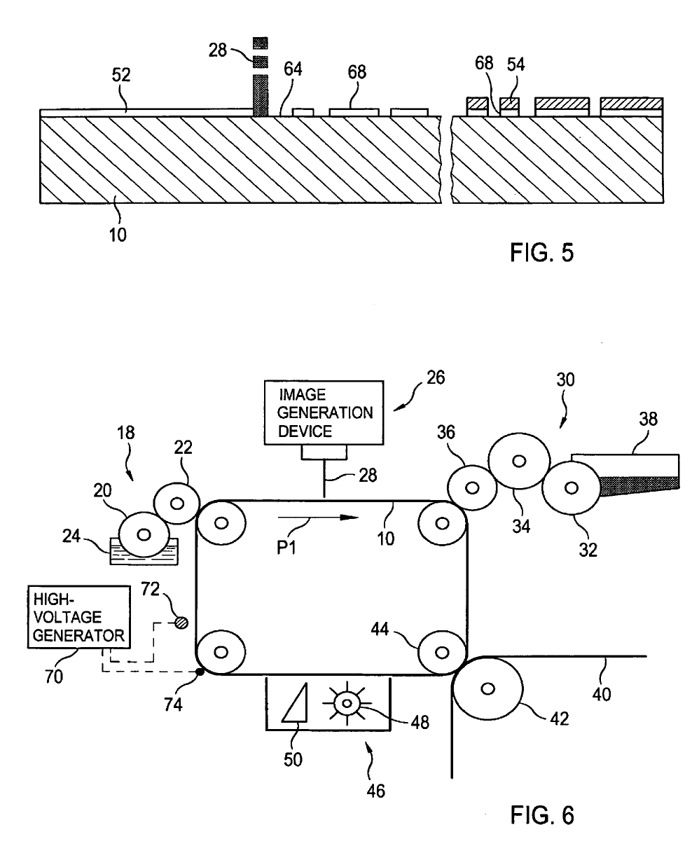

FIG. 5 shows a cross-section through the print carrier 10 before and after the structuring via the laser beam 28 for the example according to FIG. 4. The surface of the print carrier 10 is very smooth, as this is also the case in the preceding examples. The thin surfactant layer 52 is structured by the laser beam 28, meaning hydrophilic regions 68 and hydrophobic layers 64 are generated. A thin, water-containing moisture film is applied by the dampening system 18 only on the hydrophilic regions. The regions 64 are then inked by the inking system 30 with an oil-containing ink that is repelled by the fountain solution 54 in the area of the hydrophilic regions 68.

The subsequent exemplary embodiments according to FIGS. 6 through 9 describe the hydrophilization of the surface of the print carrier 10 via charging with free ions. These exemplary embodiments can also be combined with the example according to FIG. 3.

In order to ensure a good wetting with the generally ink-repelling fountain solution film, the surface energy of the print carrier 10 must be at least as high as the surface tension of the fountain solution film. This means that the value of the contact angle between the surface of the print carrier 10 and the fountain solution must assume a value below 90°. In practice, it is necessary that a contact angle of <25° has to be achieved in order to generate the necessary liquid film with a thickness of approximately 1 μm. This places a high demand on the surface energy of the print carrier, primarily when one considers the extremely high surface tension value of water, namely 72 mN/M, as a basis of the ink-repelling fountain solution. Plastic print carriers or metallic print carriers can not achieve this without further measures such as, for example, roughening, application of surfactants, generation of microcapillaries, etc. For example, the contact angle of water to polyimide or polycarbonate is approximately 75°. Even metal surfaces that, in their purest form, exhibit very high surface energies and thus the smallest contact angles show relatively hydrophobic behavior under normal environmental conditions. This is substantially connected with the oxidation layer acting on metal surfaces that always forms under normal conditions. Even the slightest impurities have a negative effect in this context for the desired surface energy. Contact angles of over 70° are herewith frequently to be encountered in practice.

In the example according to FIG. 6, a corona treatment of the surface of the print carrier 10 is effected for hydrophilization. A high-voltage generator 70 generates an alternating voltage in the range of 10 to 30 kV, preferably in the range of 15 to 20 kV, at a frequency of 10 to 40 kHz, preferably in the range of 15 to 25 kHz. An output connection of the high-voltage generator 70 is connected with an insulated electrode 72. The other output connection is, in the present case of a metallic print carrier 10, attached to a loop contact 74 that is connected with the print carrier 10.

The relatively high voltage at the electrode 72 leads to ionization of the air. A corona discharge is created, whereby the surface of the print carrier 10 is bombarded with free ions. Given a plastic surface, in addition to a cleaning effect in which organic impurities such as fat, oil, wax, etc. are typically removed, this leads to the creation of free radicals on the surface that form strongly hydrophilic functional groups in connection with oxygen. They are hereby primarily carbonyl groups (—C═O—), carboxyl groups (HOOC—), hydroperoxide groups (HOO—) and hydroxyl groups (HO—). Given metallic print carriers, the cleaning effect is in the foreground, whereby an increase of the surface energy, and thus a reactivation of the hydrophilic properties of metals, is achieved via degreasing of the surface and removal of the oxide layer. In this manner, contact angles to water of under 20° can be achieved with plastic surfaces and with metal surfaces. The corona treatment modifies the physical surface properties of the carrier beforehand, however not its mechanical properties. No visible changes are detectable, for example with a scanning electron microscope. Via variation of the height of the voltage or the frequency of the high-voltage generator, the effect on the surface of the print carrier 10 can be influenced and attuned to the respective carrier material. The hydrophilization can be improved via supply of process gases, preferably oxygen or nitrogen.

In FIG. 6, as in the example according to FIG. 1, a fountain solution is applied onto the hydrophilized surface of the print carrier 10 in the dampening system 18; a structuring with the aid of laser radiation 28 subsequently ensues. The structured fountain solution layer is inked by the inking system 30 and the ink is later transfer-printed onto the carrier material 40. Ink residues are removed in the cleaning station 46. Since the surface of the print carrier 10 is very smooth, just as in the previous example, the cleaning process is simple and is to be realized with high effectiveness. The cyclical printing process can subsequently start anew. Alternatively, a restructuring can also be omitted and the previous print image is re-inked and transfer-printed.

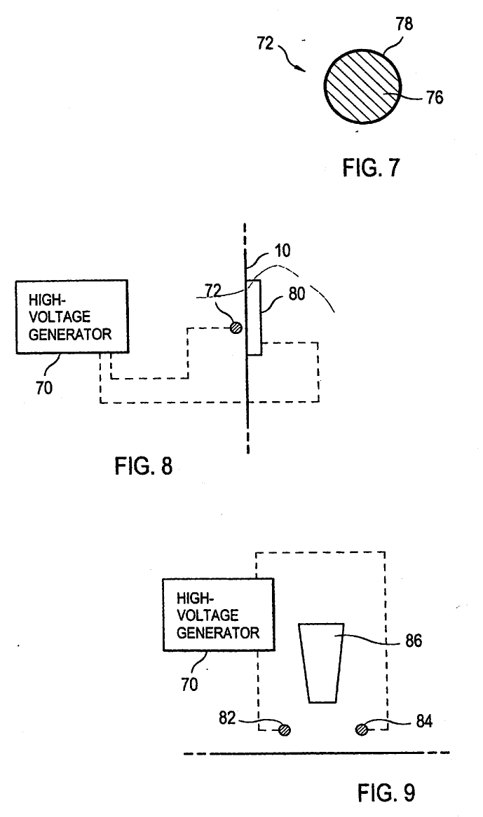

FIG. 7 shows the insulated electrode 72. A metallic core 76 is surrounded by a ceramic jacket 78. In such a design, electrical arc-overs are prevented. This is primarily advantageous when metal is used as a print carrier 10. Alternatively, the insulation can also be generated via a plastic jacket.

FIG. 8 shows the design in a print carrier 10 made from plastic. An electrode plate 80 is arranged on the side of the print carrier 10 that lies opposite the electrode 72. The electrode 72 can be executed without insulation.

FIG. 9 shows a hydrophilization method with an indirect corona treatment. The output connections of the high-voltage generator 70 are connected with two electrodes 82, 84 that are arranged above the print carrier 10. The electrical discharges generated by the high voltage between the two electrodes 82, 84 generate ions that are conducted via an air flow or process gas flow onto the surface of the print carrier 10 and here deploy the wetting-aiding effect. A blower 86 is used to generate the flow.

Alternatively, a negative pressure plasma treatment can also be used that increases the surface energy on the surface of the print carrier 10. A high voltage discharge is hereby generated under vacuum conditions (for example in the range of 0.3 to 20 mbar), ionized by the process gas and excited into the plasma state. This plasma comes in contact with the surface of the print carrier 10. The effect of the plasma is comparable with the effect of the corona treatment.

A significant increase of the surface energy, which enables a very thin application of the frequency range fountain solution, is achieved with the aid of the hydrophilization process specified in FIGS. 6 through 9. The layer thickness is typically in the range of 1 μm.

Various advantages result via the specified hydrophilization method. The roughened, porous printing plate surface as in the standard offset printing method can be foregone. Instead of this, a very smooth surface is possible whose roughness range is very low, for example in a range of the average roughness value Rₐ<1 μm. A faster and more stable cleaning event is thereby possible for the surface. For the specified printing process, neither a permanent change in the molecular or atomic structure of the material of the print carrier nor a wetting-aiding layer permanently and firmly anchored with the print carrier is necessary. Via the specified hydrophilization process, the print carrier can be optimized with regard to further requirements without consideration of the surface energy.

The specified hydrophilization process also enables the omission of the wetting-aiding additives for fountain solution used in offset printing. A further application of additional wetting-aiding substances is no longer necessary. This prevents a relatively complicated process management and reduces the additional expenses on commodities. A further advantage is also in the cleaning effect of the hydrophilization method. It supports the cleaning process necessary for the digital printing method and thus further reduces the necessary hardware expenditure.

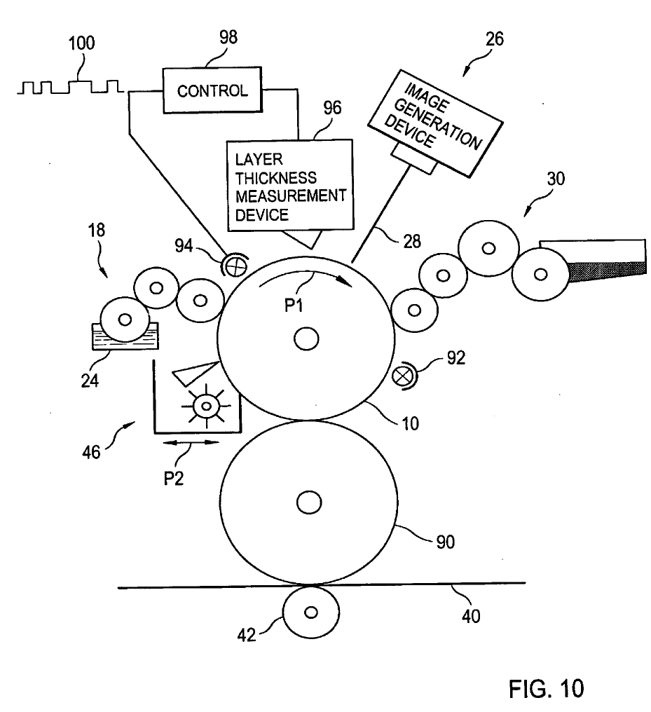

FIG. 10 shows a further exemplary embodiment. In offset printing and in particular in the digital methods, for example according to U.S. Pat. No. 5,067,404 and U.S. Pat. No. 6,295,928 by the same applicant, the constant and precisely defined thickness of the fountain solution layer on the surface of the print carrier plays a decisive role for the stability and the efficiency of the printing method. According to the example according to FIG. 10, a print device is specified that provides and monitors a defined, controllable and regulable very thin application of the fountain solution. In the standardized offset printing method, a dampening system is normally comprised of a number of rotating rollers used for the application of the fountain solution. Together with a roughened or porous printing plate directing good water, a water film sufficiently stable for the standard offset printing results. The fountain solution quantity and the thickness of the fountain solution layer can, for example, be adjusted via the adjustment of specific rollers relative to one another or the speed of the scoop roller. The storage effect of the dampening system as well as that of the printing plate hereby leads to a significantly retarded reaction to adjustment measures. However, for the generation of a sufficiently stable water film, the roughened, strong water-storing printing plates are absolutely necessary. From the prior art, it is also known to generate a very thin water film via cooling of the printing plate and the subsequent condensation of the humidity on the printing plate. The thickness of the water film is, however, strongly dependent on the environmental conditions such as humidity and temperature and is hard to keep constant over longer periods of time.

In the exemplary embodiment according to FIG. 10, a design is used that is similar to the design specified in the previously mentioned DE-A-101 32 204, which realizes a CTP method (Computer-To-Press method).

The print device shown in FIG. 10 allows different print images to be generated on the same surface of the cylindrical print carrier 10. The print device comprises the inking system 30 with a plurality of rollers via which oil-containing ink is transferred from the reservoir 38 onto the surface of the print carrier 10. The inked surface of the print carrier 10 transfers the ink onto a rubber blanket cylinder 90. From there, the ink arrives on the paper web 40, which is pressed against the rubber blanket cylinder 90 via the counter-pressure cylinder 42.

The dampening system 18 transfers fountain solution (for example water) via three rollers from the fountain solution reservoir 24 onto the surface of the print carrier 10. Before the application of the fountain solution layer, the surface of the print carrier 10 can be brought to a hydrophilic state (as this has already been specified further above) using wetting agents and/or surfactants or via a corona and/or plasma treatment. In the further course, the fountain solution layer is selectively removed via energy supply by means of a laser beam 28 and the desired image structure is created. As mentioned, the inking via the inking system 30 subsequently occurs on the ink-attracting regions of the structuring. After the structuring, the ink can be solidified by means of a fixing device 92.

In this example, two operating modes are also possible. In a first operating mode, a plurality of printing events occurs before a restructuring of the surface. The print image located on the print carrier 10 is inked and transfer-printed once per printing, meaning a multiple inking of the print image occurs. In a second operating mode, a new print image is applied on the surface of the print carrier. For this, the previous structured ink-repelling layer as well as the ink residues are to be removed, for which the cleaning station 46 is provided. This cleaning station can be pivoted onto the print carrier 10 according to the arrow P2 and pivoted away again from said print carrier 10. Further details of the design of the print device according to FIG. 10 are specified in the mentioned DE-A-101 32 204.

Viewed in the transport direction P1, an energy source 94 that emits heat energy onto the fountain solution film on the surface of the print carrier 10 is arranged after the dampening system 18. The thickness of the fountain solution layer is reduced with the aid of this energy. Viewed in the transport direction, a layer thickness measurement device 96 is located after the energy source. This layer thickness measurement device 96 determines the current thickness of the fountain solution film and emits an electrical signal corresponding to the thickness to a control 98. The control 98 compares the measured real thickness with a predetermined desired thickness. Given a desired-real value deviation, the energy source 94 is activated such that the thickness of the fountain solution layer is reduced to the desired thickness.

The layer thickness measurement device 96 can, for example, operate without contact according to the triangulation method, the transmission method or the capacitive method. One or more IR lamps, heat radiators, laser systems, laser diodes or heating elements are suitable as energy sources 94.

The cooperation of the energy source 94, the layer thickness measurement device 96 and the control 98 can be such that only a monitoring function is effected. When the layer thickness undershoots or overshoots a predetermined desired value, a corresponding warning signal is emitted and the energy supply for the energy source 94 is readjusted based thereon. The energy source 94, the layer thickness measurement device 96 and the control 98 can, however, also be incorporated into a control circuit in which the energy source 94 is activated such that, given a standard deviation between real value and desired value of the layer thickness, this standard deviation is minimized and preferably regulated to zero.

The energy source 94 can be activated by the control with the aid of an analog voltage regulation or digitally via a pulse modulation, as this is indicated by the signal series 100.

According to the example according to FIG. 10, in a first process step a fountain solution film that is constant in terms of thickness is generated over the useable width of the print carrier 10, the fountain solution film being reduced in terms of its layer thickness defined in a subsequent second step. The result is a uniform fountain solution layer with defined and very slight thickness. The subsequent structuring can thus be implemented with minimal energy and with invariable result. Overall, the print quality is thus increased. The advantages of the shown print device are that an immediate reaction to a change of the layer thickness of the fountain solution layer can ensue, that a known and defined thickness of the fountain solution layer can be set, and that extremely thin fountain solution layers can be generated. The necessary structuring energy can also be minimized, in particular for digital printing methods.

Numerous further variations of the previously specified exemplary embodiments are possible. For example, both a continuous band and a cylinder can be used as a print carrier. The transfer printing onto the carrier material can occur directly or under interposition of a rubber blanket cylinder or further intermediate cylinders for an ink separation. The layer thickness regulation according to the example according to FIG. 10 can also be used for the other examples. Likewise, a fixing of the applied ink with the aid of a fixing device can occur for the examples according to FIGS. 1 through 9. Furthermore, the cleaning station 46, the dampening system 18 and the image generation device can be inactively and actively interposed, for example via swinging.

In the previously specified print devices and printing methods according to FIGS. 1 through 10, respectively one image generation device was specified for the structuring process, said image generation device having been, for example, realized via controlled radiation of a laser system, a laser, laser diodes, LEDs or a laser diode array. Given use of a laser system, the laser beam is typically deflected parallel to the transverse axis of the band-shaped print carrier or parallel to the rotation axis of the print drum via a rotary mirror. The laser beam is modulated, for example activated and deactivated to generate the image points.

As visible from the previously specified examples, regions of a hydrophilic layer or a fountain solution must be removed for structuring, which typically ensues via vaporization or via formation of a gas bubble. For this, relatively high thermal energy is necessary that, in the case of a laser, requires an elaborate, expensive laser unit. A possible adaptation of the wavelength of the laser system to the necessary optimal wavelength of the moisture film to be irradiated or to the surface of the print carrier further increases the costs.

In the following examples for structuring methods and structuring devices that can advantageously be combined with the previously specified print device examples, a conventional radiation source is respectively used. The control of the energy flow of the radiation ensues via control elements that conduct the supplied radiation to the surface of the print carrier dependent on control signals, whereby one control element is used per image point to be generated.

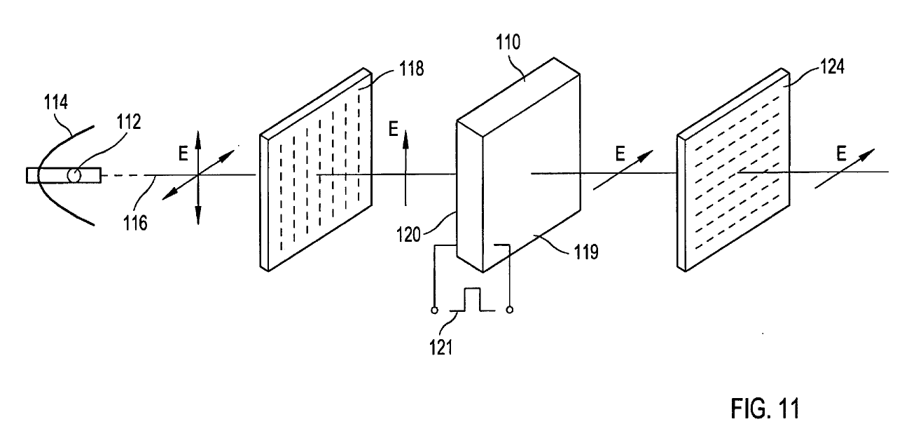

FIG. 11 shows the use of a PLZT element 110 as a control element. In FIG. 11, a lamp 112 whose radiation is concentrated by a reflector 114 is used as a thermal energy source. The radiation of a ray beam 116 is considered in detail in the following. The radiation 116 has an E-vector distributed uniformly transverse to the radiation axis, meaning it is unpolarized radiation. This radiation 116 is directed via a first polarization filter 118 which passes only one component of the E-vector, meaning henceforth polarized radiation exists. This polarized radiation is supplied to the PLZT element 110. This PLZT element is comprised of transparent electro-optical material (Polycrystalline Lanthanum modified lead Zirconate Titanate) that is coated on both sides with transparent surface electrodes 119, 120.

Via application of a pulse-shaped electrical voltage 121 to the electrodes 119, 120 of the PLZT element 110, the polarization plane of the radiation is rotated using the Kerr effect, as is schematically indicated in FIG. 11. A polarized filter 124 downstream from the PLZT element 110 passes only the radiation rotated in the polarization plane by an active PLZT element 110, said radiation then impinging on the surface of the hydrophilic layer, the surface of the fountain solution or the surface of the print carrier and there deploying a thermal effect. Via application of voltage pulses, the passage of the radiation 116 through the polarized filter 124 can thus be controlled. Given application of the Kerr effect for the PLZT element, relatively high radiation energies can be switched at high switching frequencies. The PLZT element 110 can be switched at relatively low voltages and places no particular demands on the environmental temperature.

Alternatively, the Farraday effect for the PLZT element can also be used; however, the high heat development then created is disadvantageous.

The light scatter effect is preferably used for the control of the radiation via a PLZT element. A parallel light beam is hereby converted into a divergent light beam via application of a voltage to the PLZT element. In such an arrangement, a contrast coefficient of ≧15:1 can be achieved.

A plurality of identical PLZT elements 110 is preferably combined into a single-line or multi-line PLZT array. In this manner, image points can be generated line-by-line on the surface of the print carrier via vaporization or radiation exposure. Between the respective PLZT array and the surface of the print carrier, an image optic is arranged that focuses the radiation passed by the respective PLZT element onto the surface of the print carrier. A Selfoc element is preferably used as an imaging optic. U.S. Pat. No. 4,764,776 is referenced in this context that specifies further examples of the arrangement of PLZT elements and the application of a Selfoc element. This document is hereby included by reference in the disclosure content of the present patent application.

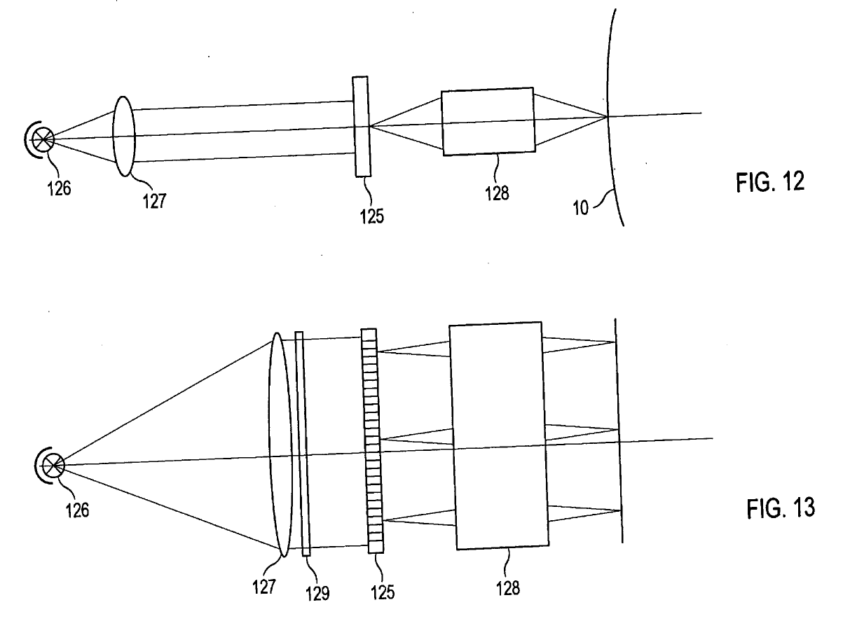

FIGS. 12 and 13 show an application example with a single-line PLZT array 125. The arrangement of a view in the line direction is shown in FIG. 12; FIG. 13 shows a view from above the line.

In FIG. 12, the radiation of a 500 W halogen lamp 126 is concentrated in the plane of the line and deflected onto the PLZT array 125 by an illumination optic 127. The radiation output by the individual PLZT elements is focused on the surface of the print carrier 10 by a Selfoc element 128.

FIG. 13 shows the arrangement according to FIG. 12 in plan view. A filter 129 for homogenization of the illumination of the PLZT elements arranged in a line for the array 125 also belongs to the illumination optics 127 that concentrate the radiation. An image point on the surface of the print carrier is associated with each PLZT element by the Selfoc element 128.

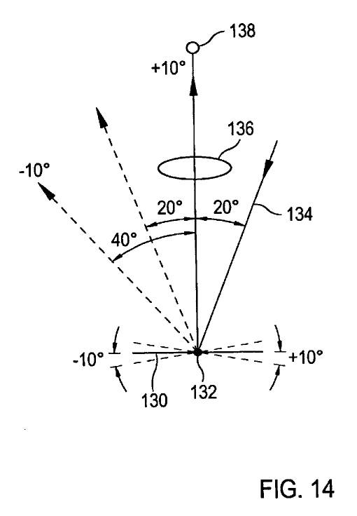

As a further example for a control element to control the radiation to be supplied per image point to the surface of the print carrier, the use of DMD elements is proposed. A DMD element (Digital Micro mirror Device) is a micromechanical component with a mirror whose normal can be pivoted around a rotation axis via application of a voltage. FIG. 14 shows the basic principle. Via application of a voltage, a micro-mirror 130 can be pivoted from its start position (shown in extended lines) around a rotation axis 132 by an angle±α, as this is indicated dashed with the example α=±10°. At an angle position of +10°, the incident radiation 134 is supplied to a collector lens 136 that concentrates the radiation. If the micro-mirror 130 is deflected by +10° via application of a voltage, the arriving radiation 134 is supplied by the collector lens 136 to an image point 138 to be irradiated on the surface of the print carrier. In the state with an angle position of 0° or −10° of the micro-mirror 130, the incident radiation 134 is deflected out of the opening range of the collector lens 136 and is ineffective, as this is indicated with dashed lines.

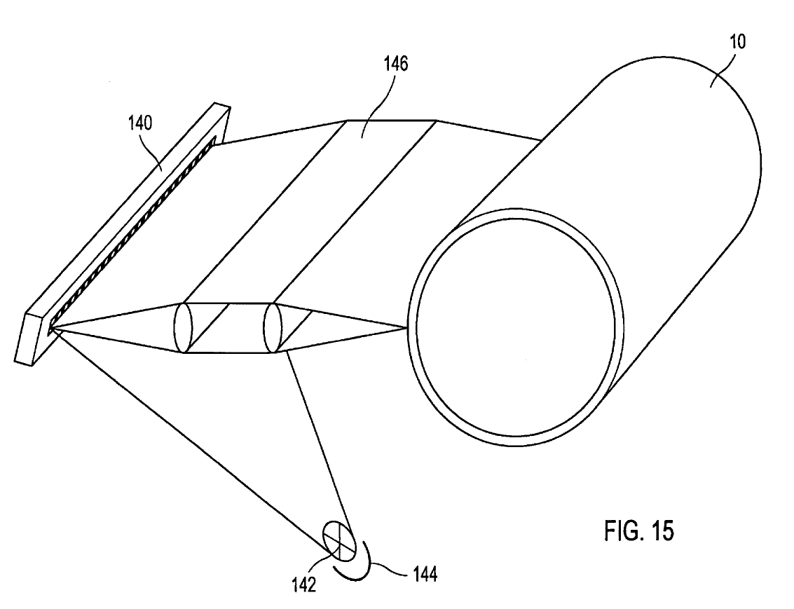

Identical DMD elements are combined into a single-line or multi-line DMD array to generate an image point line. FIG. 15 shows such an example.

A DMD array 140 receives radiation from a radiation source 142 with reflector 144. The radiation source 142 can be punctiform or rod-shaped. Each DMD element can be separately activated by a voltage. An imaging optic 146 that focuses the radiation reflected by the respective DMD element onto the surface of the print carrier 10 is arranged between the DMD array 140 and the surface of the print carrier 10. An already-mentioned Selfoc element is preferably used as an imaging optic. A line-by-line structuring can be effected on the surface of the print carrier via application of control signals to the DMD elements of the DMD array.

The DMD array 140 is preferably arranged on a cooled carrier that is cooled by water or gas.

For the aforementioned examples according to FIGS. 11 through 15, a xenon lamp or a halogen lamp in punctiform or rod-shaped arrangement is considered as a radiation source. The wavelength of the radiation radiated by the radiation operating system adapted to the fountain solution layer and/or to the material of the surface of the print carrier 10 and allows an optimal energy use. The respective radiation source can be activated pulsed in order to reduce the heat dissipation loss of the respective array. In the case of a DMD array with a width of, for example, 296 mm and mechanical switch sides ≦15 μs, print speeds of ≧3 m/s can be achieved given a resolution of 600 dpi in the writing direction, meaning in the vertical direction. Via the use of conventional radiation sources and conventional imaging optics, the structuring of the surface of the print carrier can ensue substantially more economically than this is possible with laser systems. Moreover, significantly greater degrees of freedom exist in the selection of suitable wavelength ranges, whereby a greater selection of fountain solution and material of the print carrier is also possible.

Further examples for print devices and printing methods are subsequently shown in which the specified structuring methods and structuring devices can be advantageously used.

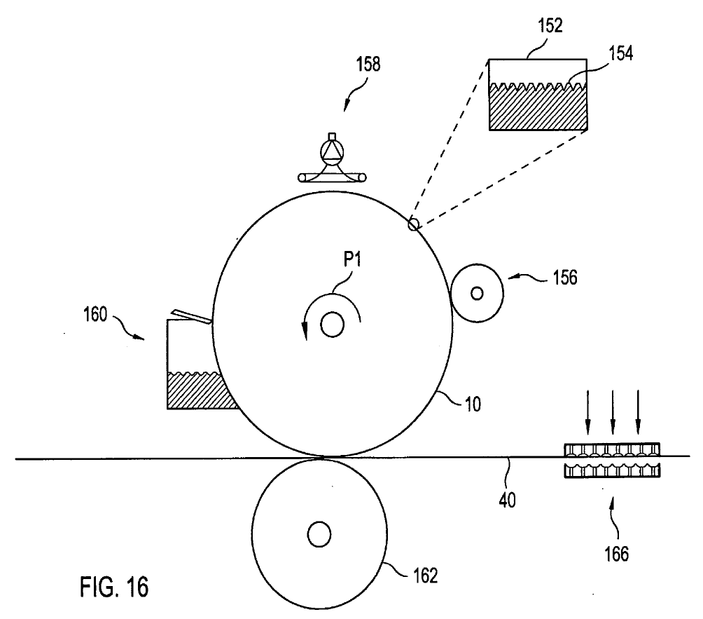

In FIG. 16, a print device is shown in which the specified method and the device for structuring can likewise be applied. A print carrier 10 (also designated as a form cylinder) has a surface structure that is shown enlarged in image section 152. The surface structure comprises cups 154 arranged two-dimensionally in a grid, for example in a grid of 300 to approximately 2500 dpi (dots per inch), preferably 600 to 1200 dpi. Corresponding image points can be printed with the aid of these cups. The cup depth is 0.1 to 50 μm, preferably 5 to 20 μm.

A dampening system 156, an image generation device 158, an inking system 160 and a counter-pressure cylinder 1622 (also called an “impression roller”) are arranged around the circumference of the cylindrical print carrier 10. The carrier material 40 is conducted through between the cylindrical print carrier 10 and the counter-pressure cylinder 162. It passes through a drying station 166 for drying.

Given rotation of the print carrier 10 in the arrow direction P1, the application of a thin, homogenous fluid layer ensues at the dampening system 156, such that all cups 154 fill with fluid, preferably water. The fountain solution application ensues, for example, via rollers, however the application can also alternatively ensue via spraying or vapor deposition.

Excess fountain solution is preferably removed with a scraper (not shown) which is downstream from the dampening system 156. The fountain solution is selectively vaporized via a digitally-operating image generation device 158, whereby ink-attracting and ink-repelling regions are generated. In the ink-attracting regions, the fluid in the cups 154 is removed; in the ink-repelling regions, the fountain solution is not removed. The image generation device 158 can, for example, be a digitally-controlled device according to FIGS. 11 through 15. Via the inking system 160, ink that adheres to the surface of the print carrier 10 in the ink-attracting regions and does not adhere in the ink-repelling regions is applied on the surface of the print carrier 10. Given use of a water-containing fountain solution, the ink is generally oil-containing. Excess ink is removed via a scraper (not shown) downstream from the inking system 160.

The printing ink is subsequently directly transfer-printed to the carrier material 40. The transfer onto the elastic intermediate carrier as specified in the patent document U.S. Pat. No. 5,295,928 is omitted. The ink transfer is effected via adhesion forces. Via corresponding execution of the printing ink with regard to its viscosity and cross-linkage, as this is known, and via suitable design of the cup shape, one achieves a very good emptying of the cups 154. Printing inks based on water, as this is used in known rotogravure methods, are preferred given use of print carriers with relatively large cup depths and their problem of complete emptying.

The carrier material is subsequently directed through a drying station 166 that dries the ink.

As mentioned, a fountain solution that comprises water is preferably used. Wetting-aiding substances, for example surfactants, can then be added to the fountain solution. Alternatively, silicon-repelling fluids can also be used in order to process silicon-containing printing inks.

In the region of the transfer printing location, an electrostatic field can be applied in order to support the emptying of the ink from the cups 154 in the surface of the print carrier 10.

As mentioned, no cleaning station is arranged between the transfer printing and the reapplication of fountain solution. The cups 154 are completely emptied. After a reapplication of fountain solution, a structuring in ink-attracting and ink-repelling regions can occur, either corresponding to the previous print image or corresponding to a new print image. In this manner, print images of smaller and larger runs can be printed with the same print carrier with high flexibility. Due to the omission of the cleaning process, which can be necessary only in simplified form and at substantially larger temporal intervals, an increased print speed can be achieved relative to the previous digital printing method.

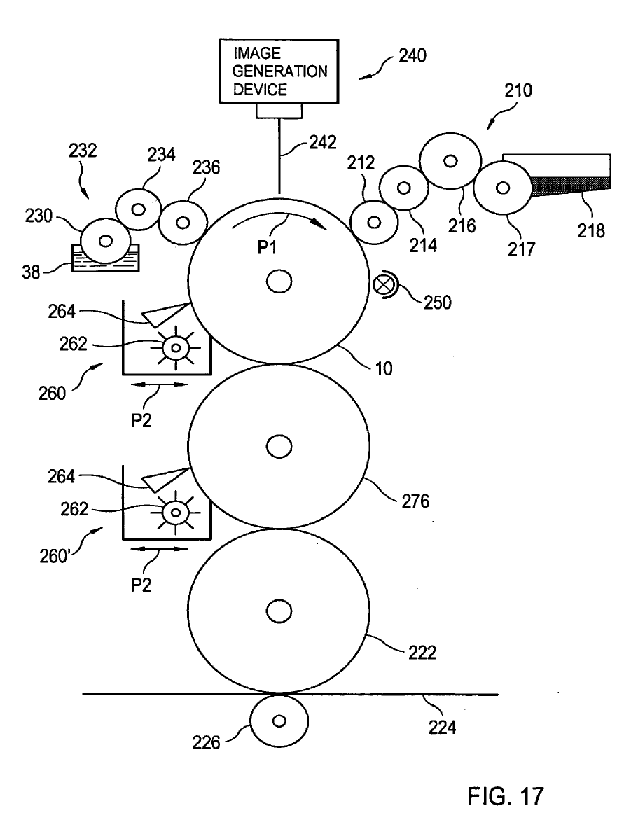

FIG. 17 schematically shows the design of a device for printing in which different print images can be generated on the same surface of the print carrier 10. This device comprises an inking system 210 with four rollers 212, 214, 216, 217 via which ink is transferred from an ink reservoir 218 onto the surface of the print carrier 10. The surface of the print carrier 10 is here a generated cylinder surface. The ink of the inked surface of the print carrier 10 is transferred onto a rubber blanket cylinder 222 in the further course, as is specified further below. From there, the ink arrives on the paper web 224, which is pressed against the rubber blanket cylinder 222 via the counter-pressure cylinder 226. The arrow P1 shown indicated in FIG. 17 shows the transport direction.

Alternatively to the fountain solution layer, an ice layer can also be used. The print carrier comprises a cooling system (not shown) to generate the ice layer. With the aid of the cooling system, the surface of the print carrier is cooled to a temperature below the freezing point of water. For the case of a normal environment with average humidity, the temperature of the surface of the print carrier is below 0° C. The water vapor contained in the surrounding air condenses on the surface of the print carrier as an ice layer as a result of condensation. An electro-thermal cooling principle, for example via the use of Peltier elements, is applied to generate the ice layer on the surface of the print carrier. Another possibility is to apply a thin water film with a thickness in the μm range. An ice layer is then created via cooling. A spraying method can be used to apply the water film, or the application ensues with the aid of rollers. The print-active surface of the print carrier is completely covered with an ice layer. The ice layer is subsequently selectively removed via energy supply by means of a laser system. The exposure occurs via the laser beam. The water of the ice layer turns into the vaporous state via the exposure with the laser beam.

In connection with the use of an ice layer, the patent document WO 98/32608 by the same applicant is referenced. This document is herewith incorporated by reference into the disclosure content of the present patent application.

The inking of the surface of the print carrier 10 according to FIG. 17 occurs with the aid of the rollers 212, 214, 216, 217 of the inking system which transfer ink from the ink reservoir 218. The ink attaches to the regions without fountain solution or in the alternative exemplary embodiment, to regions without an ice layer. The regions bearing a fountain solution or an ice layer are ink-repelling and absorb no ink. The application of the ink here ensues via a roller system. The ink can also be applied on the surface of the print carrier via spraying, scraping or condensation.

The ink applied after the structuring is solidified with the aid of a fixing device 250. This occurs via IR radiation, hot air, UV light or radiant heat. The surface is subsequently inked once or multiple times with ink from the inking system 210. The ink applied on the print carrier 10 is directly or indirectly transferred onto the rubber blanket cylinder 222 and from there onto the carrier material 224. The ink distributed onto the print carrier 10 can alternatively also be directly transferred onto the carrier material 224, whereby then the rubber blanket cylinder 222 can be foregone.

Two operating modes are possible: in a first operating mode, a plurality of printing events occurs before a restructuring of the surface. The print image located on the print carrier is inked and transfer-printed once per transfer printing, meaning a multiple inking of the print image occurs. In the case of the structuring ice layer on the surface of the print carrier, the temperature of this surface is kept below the freezing point with the aid of the cooling system.

In a second operating mode, a new print image is applied on the surface of the print carrier. For this, the previous structured ink-repelling layer is to be removed and the ink residues and the surface of the print carrier are to be cleaned and to be regenerated. For this purpose, a cleaning station 260 is activated. It comprises a brush 262 and a wiping lip 264 which are brought into contact with the surface of the print carrier and remove the structured ink-repelling layer and the ink residues. The removal of the structured ink-repelling layer occurs using ultrasound, high pressure liquid and/or vapor. The surface of the print carrier is thereby cleaned with the aid of brushes, cloths, rollers and/or scrapers. The cleaning can occur in one or more cycles using auxiliary means such as cleaning fluids and/or solvents. For activation and deactivation, the cleaning station 260 is pivoted to the print carrier in the direction of the arrow P2. The possibly present cooling system can be switched to inactive during the cleaning.

After the cleaning, as needed a regeneration of the surface of the print carrier occurs, preferably using wetting agents and/or surfactants. A corona or plasma treatment of the surface of the print carrier is also possible, such that this is brought to a hydrophilic sate. It is also to be mentioned that the surface of the print carrier comprises coatings that have a low optical penetration depth, low reflection values and a poor heat conductivity.

An intermediate cylinder 276 that effects an additional ink separation is arranged between the print carrier 10 and the rubber blanket cylinder 222. As a result of this ink separation, a larger ink quantity can be transferred onto the print carrier 10, whereby the printing form has an improved stability and the waste is reduced given a large number of printing events. A further stress reduction of the printing form can be achieved via a suitable surface of the intermediate cylinder 276. Soft and flexible surfaces that ensure a uniform ink separation are preferably used for the intermediate cylinder 276.

At the intermediate cylinder 276, a cleaning station 260′ is arranged that has the same design as the cleaning station 260. Ink residues are removed with the aid of the brush 262 and the wiping lip 264 which are contacted with the surface of the intermediate cylinder 276 via a pivot motion in the direction of the arrow P2. The intermediate cylinder 276 is hereby prepared with a new image structure for the ink transfer.

It is possible to optimize and to tune the ink separation, for example via use of a plurality of intermediate cylinders according to the type of intermediate cylinder 276. In this manner, an optimal adaptation between the layer thickness of the ink on the carrier material 224 and the layer thickness of the ink applied to the surface of the print carrier 10 can be achieved.

In FIG. 17, the fixer unit 250 is effective for fixing the ink. In an alternative, in this exemplary embodiment the fixing device 250 can be omitted because the printing form of the print carrier 10 is very stable as a result of the effected ink separation. Given omission of the fixing station 250, a reduced cleaning expenditure results since the non-fixed and solidified ink and the associated substances can be removed significantly easier. Furthermore, a time savings results via the omission of the fixing process. The time between two print jobs with different image structure can thus be significantly reduced. The waste of the printing form of the print carrier 10 is also reduced by the effected ink separation. Furthermore, the shown cleaning stations 260 and 260′ can be designed relatively simply since they only come in contact with unfixed ink, which is clearly simpler to clean than fixed ink.

The structuring devices according to FIGS. 11 through 15 can advantageously be used for the print device that is specified in the previously mentioned WO 01/02170 A by the same applicant.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A method to generate a print image on a carrier material, comprising the steps of:
covering a surface of a print carrier with a wetting-aiding surfactant layer;
covering the surfactant layer with a fountain solution layer which is one of ink-repelling and ink-attracting;
in a structuring process generating ink-attracting regions and ink-repelling regions via structuring of the fountain solution layer corresponding to a structure of the print image to be printed, and wherein to structure the fountain solution layer, radiation of a light source is directed via a control element per image point onto the fountain solution layer dependent on a control signal;
applying at the surface ink that adheres to the ink-attracting regions and that is not absorbed by the ink-repelling regions; and
transferring the applied ink onto the carrier material.

2. A method according to claim 1 wherein the surfactant layer thickness is less than 0.1 μm.

3. A device to generate a print image on a carrier material, comprising:
a pre-treatment device that applies a wetting-aiding surfactant layer onto a surface of a print carrier;
a damping device that covers the surfactant layer with a fountain solution layer which is one of ink-repelling and ink-attracting;
an image generating station in which in a structuring process ink-attracting regions and ink-repelling regions are generated in the fountain solution layer corresponding to a structure of the print image to be printed;
an ink application station wherein ink that adheres to the ink-attracting regions and that is not absorbed by the ink-repelling regions is applied on the surface;
an ink transfer station wherein the applied ink is transferred onto the carrier material;
the image generating station having a light source whose radiation is directed via a control element per image point toward the surface of the print carrier; and
the radiation being dependent on a control signal.

4. A device according to claim 3 wherein the surfactant layer is less than 0.1 μm.

5. A device according to claim 4 wherein a plurality of PLZT control elements are arranged in at least one line as an array and the structuring occurs line-by-line.

6. A device according to claim 5 wherein a gradient fiber element is used as an imaging optic that focuses radiation passed by the respective PLZT element.

7. A device according to claim 3 wherein a DMD element is used as the control element.

8. A device according to claim 3 wherein a wavelength of radiation radiated by said light source is adapted to the fountain solution layer.

9. A device according to claim 3 wherein the print carrier comprises a band in the shape of a closed loop.

10. A device according to claim 3 wherein the print carrier comprises a bend in the shape of a drum.

11. A device according to claim 10 wherein the drum has cups receiving the fountain solution layer.

12. A device according to claim 3 wherein a cooling system makes the fountain solution layer an ice layer.

13. A device according to claim 3 wherein a cleaning station following the ink station removes remaining portions of the ink and fountain layer.

14. A device according to claim 3 wherein the light source comprises a laser beam.

15. A method to generate a print image on a carrier material, comprising the steps of:
subjecting a surface of a print carrier to a corona treatment to create a hydrophilization layer via charging with free ions;
covering the hydrophilization layer with a fountain solution layer which is one of ink-repelling and ink-attracting;
in a structuring process generating ink-attracting regions and ink-repelling regions via structuring the fountain solution layer corresponding to a structure of the print image to be printed, and wherein to structure the fountain solution layer, radiation of a light source is directed via a control element per image point onto the fountain solution layer dependent on a control signal;
applying at the surface ink that adheres to the ink-attracting regions and that is not absorbed by the ink-repelling regions; and
transferring the applied ink onto the carrier material.
